(19) United States
(12) Patent Application Publication
(10) Pub. No.: US 2006/0072837 A1
(43) Pub. Date: Apr. 6, 2006

(54) Mobile imaging application, device architecture, and service platform architecture

(76) Inventors: John D. Ralston, Portola Valley, CA (US); Krasimir D. Kolarov, Menlo Park, CA (US); Steven E. Saunders, Cupertino, CA (US)

Correspondence Address: GREENBERG TRAURIG, LLP, 1900 UNIVERSITY AVENUE, FIFTH FLOOR, EAST PALO ALTO, CA, 94303, US

(21) Appl. No.: 11/249,561

(22) Filed: Oct. 12, 2005

Related U.S. Application Data
(63) Continuation-in-part of application No. 10/944,437, filed on Sep. 16, 2004.
(63) Continuation-in-part of application No. 10/418,649, filed on Apr. 17, 2003.
(63) Continuation-in-part of application No. 10/418,363, filed on Apr. 17, 2003.
(63) Continuation-in-part of application No. 10/447,455, filed on May 28, 2003.
(63) Continuation-in-part of application No. 10/447,514, filed on May 28, 2003.
(63) Continuation-in-part of application No. 10/955,240, filed on Sep. 29, 2004.
(60) Provisional application No. 60/618,558, filed on Oct. 12, 2004.
(60) Provisional application No. 60/618,938, filed on Oct. 13, 2004.
(60) Provisional application No. 60/654,058, filed on Feb. 16, 2005.

(51) Int. Cl. G06K 9/36

(52) U.S. Cl. 382/232

(57) ABSTRACT

Systems and methods are provided for compressing and decompressing still image and video image data in mobile devices. Corresponding mobile device architectures, and service platform architectures for transmitting, storing, editing and transcoding still images and video images over wireless and wired networks and viewing them on display-enabled devices are also provided.

### RELATED APPLICATIONS

The present application claims priority from provisional applications filed Oct. 12, 2004 under U.S. Patent Application No. 60/618,558 entitled MOBILE IMAGING APPLICATION, DEVICE ARCHITECTURE, AND SERVICE PLATFORM ARCHITECTURE; filed Oct. 13, 2004 under U.S. Patent Application No. 60/618,938 entitled VIDEO MONITORING APPLICATION, DEVICE ARCHITECTURES, AND SYSTEM ARCHITECTURE; filed Feb. 16, 2005 under U.S. Patent Application No. 60/654,058 entitled MOBILE IMAGING APPLICATION, DEVICE ARCHITECTURE, AND SERVICE PLATFORM ARCHITECTURE AND SERVICES; each of which is incorporated herein by reference in its entirety.

The present application is a continuation-in-part of U.S. patent application Ser. No. 10/944,437 filed Sep. 16, 2004 entitled MULTIPLE CODEC-IMAGER SYSTEM AND METHOD, now U.S. Publication No. U.S. 2005/0104752 published on May 19, 2005; continuation-in-part of U.S. patent application Ser. No. 10/418,649 filed Apr. 17, 2003 entitled SYSTEM, METHOD AND COMPUTER PROGRAM PRODUCT FOR IMAGE AND VIDEO TRANSCODING, now U.S. Publication No. U.S. 2003/0206597 published on Nov. 6, 2003; continuation-in-part of U.S. patent application Ser. No. 10/418,363 filed Apr. 17, 2003 entitled WAVELET TRANSFORM SYSTEM, METHOD AND COMPUTER PROGRAM PRODUCT, now U.S. Publication No. U.S. 2003/0198395 published on Oct. 23, 2003; continuation-in-part of U.S. patent application Ser. No. 10/447,455 filed on May 28, 2003 entitled PILE-PROCESSING SYSTEM AND METHOD FOR PARALLEL PROCESSORS, now U.S. Publication No. U.S. 2003/0229773 published on Dec. 11, 2003; continuation-in-part of U.S. patent application Ser. No. 10/447,514 filed on May 28, 2003 entitled CHROMA TEMPORAL RATE REDUCTION AND HIGH-QUALITY PAUSE SYSTEM AND METHOD, now U.S. Publication No. U.S. 2003/0235340 published on Dec. 25, 2003; continuation-in-part of U.S. patent application Ser. No. 10/955,240 filed Sep. 29, 2004 entitled SYSTEM AND METHOD FOR TEMPORAL OUT-OF-ORDER COMPRESSION AND MULTI-SOURCE COMPRESSION RATE CONTROL, now U.S. Publication No. U.S. 2005/0105609 published on May 19, 2005; continuation-in-part of U.S. application Ser. No. ______ filed Sep. 20, 2005 entitled COMPRESSION RATE CONTROL SYSTEM AND METHOD WITH VARIABLE SUBBAND PROCESSING (Attorney Docket No. 74189-200301/US) which claims priority from provisional application No. 60/612,311 filed Sep. 21, 2004; CIP of U.S. application Ser. No. ______ filed Sep. 21, 2005 entitled MULTIPLE TECHNIQUE ENTROPY CODING SYSTEM AND METHOD (Attorney Docket No. 74189-200401/US), which claims priority from provisional application No. 60/612,652 filed Sep. 22, 2004; CIP of U.S. application Ser. No. ______ filed Sep. 21, 2005 entitled PERMUTATION PROCRASTINATION (Attorney Docket No. 74189-200501/US), which claims priority from provisional application No. 60/612,651 filed Sep. 22, 2004; each of which is incorporated herein by reference in its entirety. This application also incorporates by reference in its entirety U.S. Pat. No. 6,825,780 issued on Nov. 30, 2004 entitled MULTIPLE CODEC-IMAGER SYSTEM AND METHOD; U.S. Pat. No. 6,847,317 issued on Jan. 25, 2005 entitled SYSTEM AND METHOD FOR A DYADIC-MONOTONIC (DM) CODEC.

### FIELD OF THE INVENTION

The present invention relates to data compression, and more particularly to still image and video image recording in mobile devices, to corresponding mobile device architectures, and service platform architectures for transmitting, storing, editing and transcoding still images and video images over wireless and wired networks and viewing them on display-enabled devices as well as distributing and updating codecs across networks and devices.

### BACKGROUND OF THE INVENTION

Directly digitized still images and video requires many “bits.” Accordingly, it is common to compress images and video for storage, transmission, and other uses. Several basic methods of compression are known, and very many specific variants of these. A general method can be characterized by a three-stage process: transform, quantize, and entropy-code. Many image and video compressors share this basic architecture, with variations.

The intent of the transform stage in a video compressor is to gather the energy or information of the source picture into as compact a form as possible by taking advantage of local similarities and patterns in the picture or sequence. Compressors are designed to work well on “typical” inputs and can ignore their failure to compress “random” or “pathological” inputs. Many image compression and video compression methods, such as MPEG-2 and MPEG-4, use the discrete cosine transform (DCT) as the transform stage. Some newer image compression and video compression methods, such as MPEG-4 static texture compression, use various wavelet transforms as the transform stage.

Quantization typically discards information after the transform stage. The reconstructed decompressed image then is not an exact reproduction of the original.

Entropy coding is generally a lossless step: this step takes the information remaining after quantization and usually codes it so that it can be reproduced exactly in the decoder. Thus the design decisions about what information to discard in the transform and quantization stages is typically not affected by the following entropy-coding stage.

A limitation of DCT-based video compression/decompression (codec) techniques is that, having been developed originally for video broadcast and streaming applications, they rely on the encoding of video content in a studio environment, where high-complexity encoders can be run on computer workstations. Such computationally complex encoders allow computationally simple and relatively inexpensive decoders (players) to be installed in consumer playback devices. However, such asymmetric encode/decode technologies are a poor match to mobile multimedia devices, in which it is desirable for video messages to be captured (and encoded) in real time in the handset itself, as well as played back. As a result, and due to the relatively small computational capabilities and power sources in mobile devices, video images in mobile devices are typically limited to much smaller image sizes and much lower frame rates than in other consumer products.

### SUMMARY OF THE INVENTION

The instant invention presents solutions to the shortcomings of prior art compression techniques and provides a highly sophisticated yet computationally highly efficient image compression (codec) that can be implemented as an all-software (or hybrid) application on mobile handsets, reducing the complexity of the handset architecture and the complexity of the mobile imaging service platform architecture. Aspects of the present invention's all-software or hybrid video codec solution substantially reduces or eliminates baseband processor and video accelerator costs and requirements in multimedia handsets. Combined with the ability to install the codec post-production via OTA download, the present invention in all-software or hybrid solutions substantially reduces the complexity, risk, and cost of both handset development and video messaging service architecture and deployment. Further, according to aspects of the present invention, software video transcoders enable automated over-the-network (OTN) upgrade of deployed MMS control (MMSC) infrastructure as well as deployment or upgrade of codecs to mobile handsets. The present invention's wavelet transcoders provide carriers with complete interoperability between the wavelet video format and other standards-based and proprietary video formats. The present all-software or hybrid video platform allows rapid deployment of new MMS services that leverage processing speed and video production accuracy not available with prior art technologies. The present wavelet codecs are also unique in their ability to efficiently process both still images and video, and can thus replace separate MPEG and JPEG codecs with a single lower-cost and lower-power solution that can simultaneously support both mobile picture-mail and video-messaging services as well as other services.

### BRIEF DESCRIPTION OF THE DRAWINGS

FIG. 1 illustrates physical display size and resolution differences between common video display formats.

FIG. 2 schematically illustrates a system for joint source-channel coding.

FIG. 3 illustrates a mobile imaging handset architecture.

FIG. 4 illustrates a mobile imaging service platform architecture.

FIG. 5 schematically compares the differences in processing resources between a DCT encoder and an improved wavelet encoder of the present invention.

FIG. 6 schematically illustrates an improved system for joint source-channel coding.

FIG. 7 illustrates an improved mobile imaging handset architecture.

FIG. 8 illustrates an improved mobile imaging service platform architecture.

FIG. 9 illustrates a framework for performing an over the air upgrade of a video gateway.

FIG. 10 illustrates implementation options for a software imaging application.

FIG. 11 illustrates implementation options for a hardware-accelerated imaging application.

FIG. 12 illustrates implementation options for a hybrid hardware accelerated and software imaging application.

### DETAILED DESCRIPTION OF THE PREFERRED EMBODIMENTS

Wavelet-Based Image Processing

A wavelet transform comprises the repeated application of wavelet filter pairs to a set of data, either in one dimension or in more than one. For still image compression, a 2-D wavelet transform (horizontal and vertical) can be utilized. Video codecs can use a 3-D wavelet transform (horizontal, vertical, and temporal). An improved, symmetrical 3-D wavelet-based video compression/decompression (codec) device is desirable to reduce the computational complexity and power consumption in mobile devices well below those required for DCT-based codecs, as well as to enable simultaneous support for processing still images and video images in a single codec. Such simultaneous support for still images and video images in a single codec would eliminate the need for separate MPEG (video) and JPEG (still image) codecs, or greatly improve compression performance and hence storage efficiency with respect to Motion JPEG codecs.

Mobile Image Messaging

According to aspects of the present invention, there is facilitated in the mobile handset and services field, richer content, utilizing more bandwidth and generating significantly higher average revenue per user (ARPU) for mobile service providers. Mobile multimedia service (MMS) is the multimedia evolution of the text-based short message service (SMS). Aspects of the present invention facilitate a new MMS application. That new application is video messaging. Video messaging, according to the present invention, provides a highly improved system for responding to target audiences' need to communicate personal information. Such mobile image messaging requires the addition of digital camera functionality (still images) and/or camcorder functionality (video images) to mobile handsets, so that subscribers can both capture (encode) video messages that they wish to send, and play back (decode) video messages that they receive.

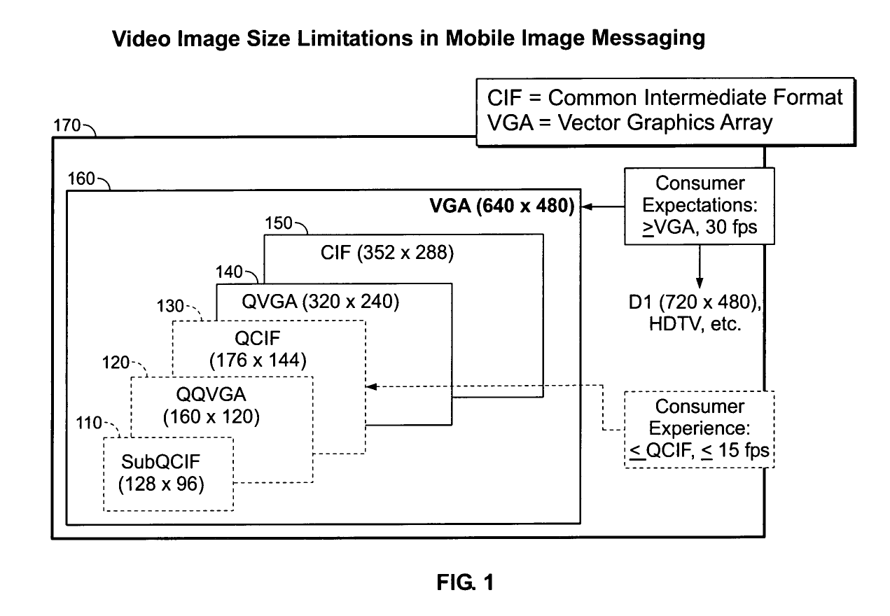

While some mobile image messaging services and applications currently exist, they are limited to capturing and transmitting much smaller-size and lower-frame-rate video images than those typically captured and displayed on other multimedia devices (see FIG. 1), such as TVs, personal computers, and digital video camcorders. As shown in FIG. 1, the smallest current format, SubQCIF 110 (SubQ-common intermediate format) is 128 pixels (picture elements) wide by 96 pixels high, QQVGA 120 (QQ-Vector graphics array) is 160 by 120 pixels, QCIF 130 is 176 by 144 pixels, QVGA 140 is 320 by 240 pixels, CIF 150 is 352 by 288 pixels, VGA 160 is 640 by 480 pixels, and the largest current format, D1/HDTV (high-definition television), is 720 by 480 pixels. Mobile image messaging services and applications capable of supporting VGA (or larger) video at a frame rate of 30 fps or higher (as provided and enabled by aspects of the present invention) would be far preferable.

Adaptive Joint Source-Channel Coding

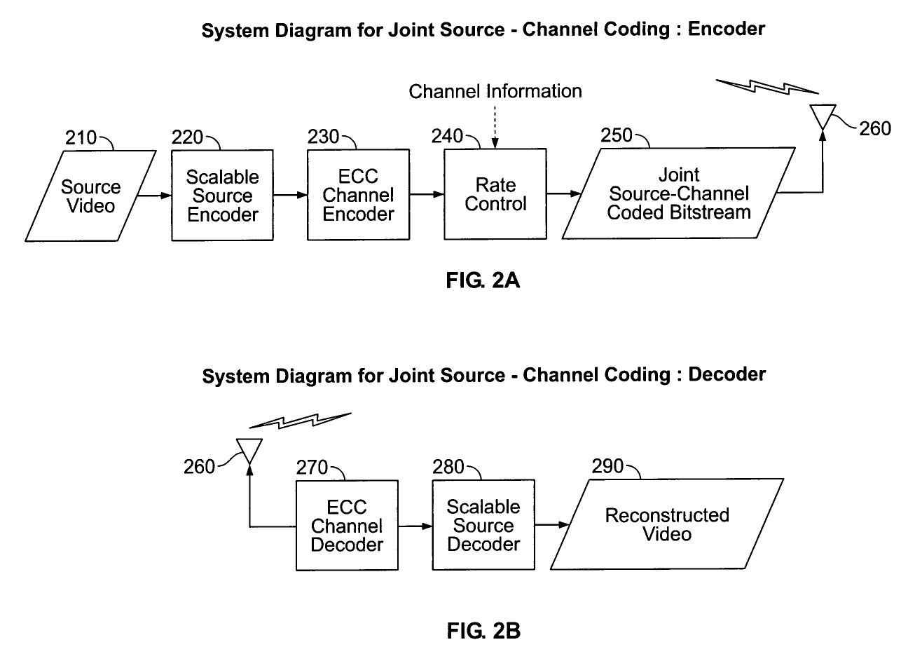

Video transmission over mobile networks is challenging in nature because of the higher data rates typically required, in comparison to the transmission of other data/media types such as text, audio, and still images. In addition, the limited and varying channel bandwidth, along with the fluctuating noise and error characteristics of mobile networks impose further constraints and difficulties on video transport. According to aspects of the present invention, various joint source-channel coding techniques can be applied to adapt the video bit stream to different channel conditions (see FIG. 2). Further, the joint source-channel coding approach of the present invention is scalable, so as to adapt to varying channel bandwidths and error characteristics. Furthermore, it supports scalability for multicast scenarios, in which different devices at the receiving end of the video stream may have different limitations on decoding computational power and display capabilities.

As shown in FIG. 2, and pursuant to aspects of the present invention, the source video sequence 210 is first source coded (i.e. compressed) by source encoder 220, followed by error correction code (ECC) channel coding 230. In prior art mobile networks, source coding typically uses such DCT-based compression techniques as, H.263, MPEG-4, or Motion JPEG. Such coding techniques could not be adjusted as can that of the present invention to provide real time adjustment of the degree of compression carried out in the source encoder. This aspect of the present invention provides significant advantages particularly when video is being captured, encoded and transmitted through the communications network in real or near real time (as compared to embodiments in which the video is captured, encoded and stored for later transmission). Exemplary channel coding methods are Reed-Solomon codes, BCH codes, FEC codes, and turbo codes. The joint source and channel coded video bit stream then passes through the rate controller 240 to match the channel bandwidth requirement while achieving the best reconstructed video quality. The rate controller 240 performs discrete rate-distortion computations on the compressed video bit stream before it sends the video bit stream 250 for transmission over the channel 260. Due to limitations in computational power in mobile devices, typical rate controllers only consider the available channel bandwidth, and do not explicitly consider the error characteristics of the transmission channel. According to aspects of the present invention, the source encoder has the capability of adjusting the compression so as to achieve variations in the compression ratio as small as from 1 to 5% and also from 1 to 10%. This is particularly enabled when varied compression factors are applied to separate subbands of data that together represent the data of one or more video images.

During decoding, as shown in FIG. 2b, the joint source-channel coded bitstream 250 is received over channel 260 and ECC channel decoded in step 270, source decoded in step 280 to render reconstructed video 290.

The present invention provides improved adaptive joint-source channel coding based on algorithms with higher computational efficiency, so that both instantaneous and predicted channel bandwidth and error conditions can be utilized in all three of the source coder 220, the channel coder 230, and the rate controller 240 to maximize control of both the instantaneous and average quality (video rate vs. distortion) of the reconstructed video signal.

The improved adaptive joint-source channel coding technique provided by the present invention further allows wireless carriers and MMS service providers the ability to offer a greater range of quality-of-service (QoS) performance and pricing levels to their consumer and enterprise customers, thus maximizing the revenues generated using their wireless network infrastructure.

Multicast scenarios require a single adaptive video bit stream that can be decoded by many users. This is especially important in modern, large-scale, heterogeneous networks, in which network bandwidth limitations make it impractical to transmit multiple simulcast video signals specifically tuned for each user. Multicasting of a single adaptive video bit stream greatly reduces the bandwidth requirements, but requires generating a video bit stream that is decodable for multiple users, including high-end users with broadband wireless or wire line connections, and wireless phone users, with limited bandwidth and error-prone connections. Due to limitations in computational power in mobile devices, the granularity of adaptive rate controllers is typically very coarse, for example producing only a 2-layer bit stream including a base layer and one enhancement layer.

Another advantage provided by the present invention's improved adaptive joint-source channel coding based on algorithms with higher computational efficiency is that it enables support for a much higher level of network heterogeneity, in terms of channel types (wireless and wire line), channel bandwidths, channel noise/error characteristics, user devices, and user services.

Mobile Imaging Handset Architecture

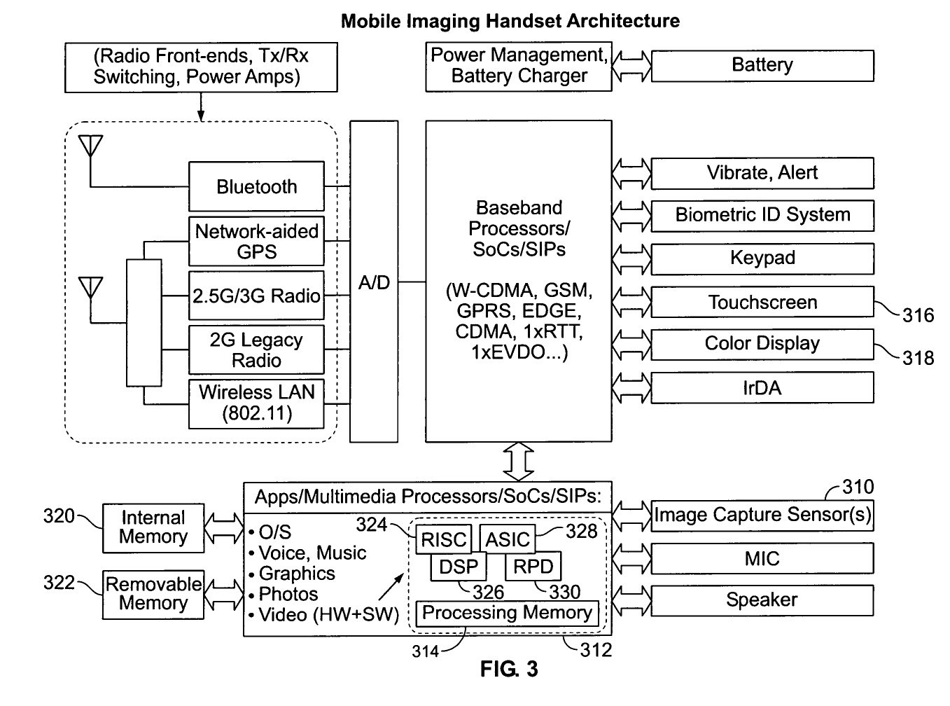

Referring now to FIG. 3, the addition of digital camcorder functionality to mobile handsets may involve the following functions, either in hardware, software, or as a combination of hardware and software:

imager array 310 (typically array of CMOS or CCD pixels), with corresponding pre-amps and analog-to-digital (A/D) signal conversion circuitry

image processing functions 312 such as pre-processing, encoding/decoding (codec), post-processing

buffering 314 of processed images for non-real-time transmission or real-time streaming over wireless or wire line networks

one or more image display screens, such as a touchscreen 316 and/or a color display 318

local image storage on built-in memory 320 or removable memory 322.

Using codecs based on DCT transforms, such as MPEG-4, commercially available imaging-enabled mobile handsets are limited to capturing smaller-size and lower-frame-rate video images than those typically captured and displayed on other multimedia devices, such as TVs, personal computers, and digital video camcorders. These latter devices typically capture/display video images in VGA format (640×480 pixels) or larger, at a display rate of 30 frames-per-second (fps) or higher, whereas commercially available imaging-enabled mobile handsets are limited to capturing video images in QCIF format (176×144 pixels) or smaller, at a display rate of 15 fps or lower. This reduced video capture capability is due to the excessive processor power consumption and buffer memory required to complete the number, type, and sequence of computational steps associated with video compression/decompression using DCT transforms. Even with this reduced video capture capability of commercially available mobile handsets, specially designed integrated circuit chips have been needed to be built into the handset hardware to accomplish the compression and decompression.

Using commercially available video codec and microprocessor technologies would lead to very complex, power-hungry, and expensive architectures with long design and manufacturing lead times for mobile imaging handsets that would attempt to capture VGA (or larger) video at a frame rate of 30 fps or higher. Such handset architectures would require codecs that utilize a combination of both software programs and hardware accelerators running on a combination of reduced instructions set (RISC) processors 324, digital signal processors (DSPs) 326, application-specific integrated circuits (ASICs) 328, and reconfigurable processing devices (RPDs) 330, together with larger buffer memory blocks 314 (typical memory capacity of 1 Mbyte or more). These codec functions might be implemented using such RISC processors 324, DSPs 326, ASICs 328, and RPDs 330 as separate integrated circuits (ICs), or might combine one or more of the RISC processors 324, DSPs 326, ASICs 328, and RPDs 330 integrated together in a system-in-a-package (SIP) or system-on-a-chip (SoC).

Codec functions running on RISC processors 324 or DSPs 326 in conjunction with the above hardware can be software routines, with the advantage that they can be modified in order to correct errors or upgrade functionality. The disadvantage of implementing certain complex, repetitive codec functions as software is that the resulting overall processor resource and power consumption requirements typically exceed those available in mobile communications devices. Codec functions running on ASICs 328 are typically fixed hardware implementations of complex, repetitive computational steps, with the advantage that specially tailored hardware acceleration can substantially reduce the overall power consumption of the codec. The disadvantages of implementing certain codec functions in fixed hardware include longer and more expensive design cycles, the risk of expensive product recalls in the case where errors are found in the fixed silicon implementation, and the inability to upgrade fixed silicon functions in the case where newly developed features are to be added to the imaging application. Codec functions running on RPDs 330 are typically routines that require both hardware acceleration and the ability to add or modify functionality in final mobile imaging handset products. The disadvantage of implementing certain codec functions on RPDs 330 is the larger number of silicon gates and higher power consumption required to support hardware reconfigurability in comparison to fixed ASIC 328 implementations.

An imaging application constructed according to some aspects of the present invention reduces or eliminates complex, repetitive codec functions so as to enable mobile imaging handsets to capture VGA 160 (or larger) video at a frame rate of 30 fps with an all-software architecture. This arrangement simplifies the above architecture and enables handset costs compatible with high-volume commercial deployment.

New multimedia handsets may also be required to not only support picture and video messaging capabilities, but also a variety of additional multimedia capabilities (voice, music, graphics) and wireless access modes (2.5G and 3G cellular access, wireless LAN, Bluetooth, GPS, etc.). The complexity and risk involved in developing, deploying, and supporting such products makes over-the-air (OTA) distribution and management of many functions and applications very desirable, in order to more efficiently deploy new revenue-generating services and applications, and to avoid costly product recalls. The all-software imaging application provided by aspects of the present invention enables OTA distribution and management of the imaging application by mobile operators.

Mobile Java Applications

Java technology brings a wide range of devices, from servers to desktops to mobile devices, together under one language and one technology. While the applications for this range of devices differ, Java technology works to bridge those differences where it counts, allowing developers who are functional in one area to leverage their skills across the spectrum of devices and applications.

First introduced to the Java community by Sun Microsystems in June 1999, J2ME (Java 2, Micro Edition) was part of a broad initiative to better meet the diverse needs of Java developers. With the Java 2 Platform, Sun redefined the architecture of the Java technology, grouping it into three editions. Standard Edition (J2SE) offered a practical solution for desktop development and low-end business applications. Enterprise Edition (J2EE) was for developers specializing in applications for the enterprise environment. Micro Edition (J2ME) was introduced for developers working devices with limited hardware resources, such as PDAs, cell phones, pagers, television set top boxes, remote telemetry units, and many other consumer electronic and embedded devices.

J2ME is aimed at machines with as little as 128 KB of RAM and with processors a lot less powerful than those used on typical desktop and server machines. J2ME actually consists of a set of profiles. Each profile is defined for a particular type of device—cell phones, PDAs, etc.—and consists of a minimum set of class libraries required for the particular type of device and a specification of a Java virtual machine required to support the device. The virtual machine specified in any J2ME profile is not necessarily the same as the virtual machine used in Java 2 Standard Edition (J2SE) and Java 2 Enterprise Edition (J2EE).

It is not feasible to define a single J2ME technology that would be optimal, or even close to optimal, for all of the devices listed above. The differences in processor power, memory, persistent storage, and user interface are simply too severe. To address this problem, Sun divided and then subdivided the definition of devices suitable for J2ME into sections. With the first slice, Sun divided devices into two broad categories based on processing power, memory, and storage capability, with no regard for intended use. The company then defined a stripped-down version of the Java language that would work within the constraints of the devices in each category, while still providing at least minimal Java language functionality.

Next, Sun identified within each of these two categories classes of devices with similar roles—so, for example, all cell phones fell within one class, regardless of manufacturer. With the help of its partners in the Java Community Process (JCP), Sun then defined additional functionality specific to each vertical slice.

The first division created two J2ME configurations: Connected Device Configuration (CDC) and Connected, Limited Device Configuration (CLDC). A configuration is a Java virtual machine (JVM) and a minimal set of class libraries and APIs providing a run-time environment for a select group of devices. A configuration specifies a least common denominator subset of the Java language, one that fits within the resource constraints imposed by the family of devices for which it was developed. Because there is such great variability across user interface, function, and usage, even within a configuration, a typical configuration does not define such important pieces as the user interface toolkit and persistent storage APIs. The definition of that functionality belongs, instead, to what is called a profile.

A J2ME profile is a set of Java APIs specified by an industry-led group that is meant to address a specific class of device, such as pagers and cell phones. Each profile is built on top of the least common denominator subset of the Java language provided by its configuration, and is meant to supplement that configuration. Two profiles important to mobile handheld devices are: the Foundation profile, which supplements the CDC, and the Mobile Information Device Profile (MIDP), which supplements the CLDC. More profiles are in the works, and specifications and reference implementations should begin to emerge soon.

The Java Technology for the Wireless Industry (JTWI) specification, JSR 185, defines the industry-standard platform for the next generation of Java technology-enabled mobile phones. JTWI is defined through the Java Community Process (JCP) by an expert group of leading mobile device manufacturers, wireless carriers, and software vendors. JTWI specifies the technologies that must be included in all JTWI-compliant devices: CLDC 1.0 (JSR 30), MIDP 2.0 (JSR 118), and WMA 1.1 (JSR 120), as well as CLDC 1.1 (JRS 139) and MMAPI (JSR 135) where applicable. Two additional JTWI specifications that define the technologies and interfaces for mobile multimedia devices are JSR-135 (“Mobile Media API”) and JSR-234 (“Advanced Multimedia Supplements”).

The JTWI specification raises the bar of functionality for high-volume devices, while minimizing API fragmentation and broadening the substantial base of applications that have already been developed for mobile phones. Benefits of JTWI include:

Interoperability: The goal of this effort is to deliver a predictable environment for application developers, and a deliverable set of capabilities for device manufacturers. Both benefit greatly by adopting the JTWI standard: manufacturers from a broad range of compatible applications, software developers from a broad range of devices that support their applications.

Clarification of security specification: The JSR 185 specification introduces a number of clarifications for untrusted applications with regard to the “Recommended Security Policy for GSM/UMTS-Compliant Devices” defined in the MIDP 2.0 specification. It extends the base MIDIet suite security framework defined in MIDP 2.0.

Road map: A key feature of the JTWI specification is the road map, an outline of common functionality that software developers can expect in JTWI-compliant devices. January 2003 saw the first in a series of road maps expected to appear at six- to nine-month intervals, which will describe additional functionality consistent with the evolution of mobile phones. The road map enables all parties to plan for the future with more confidence: carriers can better plan their application deployment strategy, device manufacturers can better determine their product plans, and content developers can see a clearer path for their application development efforts. Carriers in particular will, in the future, rely on a Java VM to abstract/protect underlying radio/network functions from security breaches such as viruses, worms, and other “attacks” that currently plaque the public Internet.

According to aspects of the present invention, the previously described imaging application is Java-based to allow for “write-once, run-anywhere” portability across all Java-enabled handsets, Java VM security and handset/network robustness against viruses, worms, and other mobile network security “attacks”, and simplified OTA codec download procedures. According to further aspects, the Java-based imaging application conforms to JTWI specifications JSR-135 (“Mobile Media API”) and JSR-234 (“Advanced Multimedia Supplements”).

Mobile Imaging Service Platform Architecture

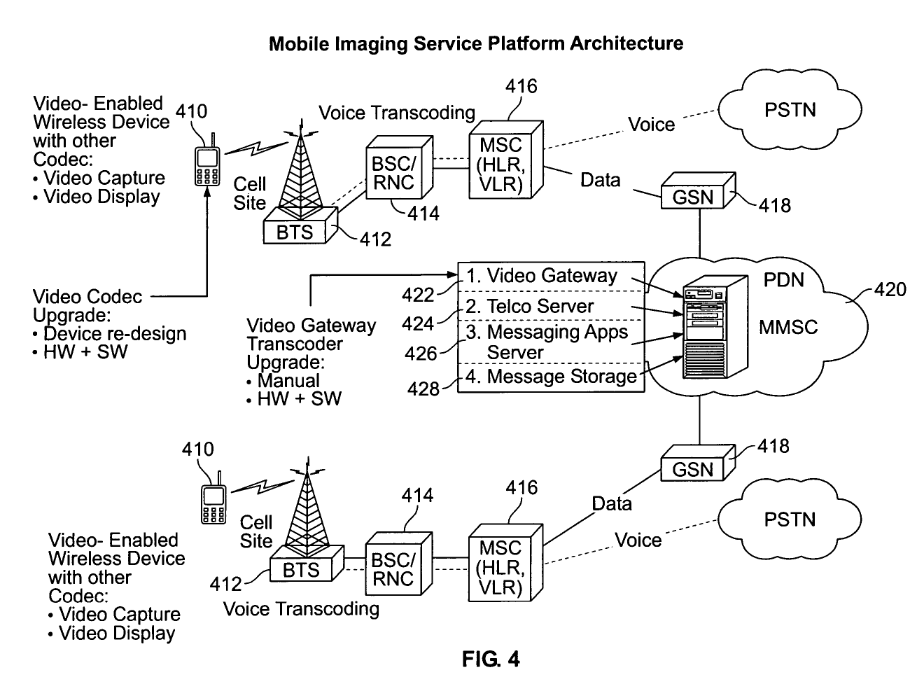

Components of a mobile imaging service platform architecture (see FIG. 4) can include:
Mobile Handsets 410
Mobile Base stations (BTS) 412
Base station Controller/Radio Network Controller (BSC/RNC) 414
Mobile Switching Center (MSC) 416
Gateway Service Node (GSN) 418
Mobile Multimedia Service Controller (MMSC) 420

Typical functions included in the MMSC (see FIG. 4) include:
Video gateway 422
Telco server 424
MMS applications server 426
Storage server 428

The video gateway 422 in an MMSC 420 serves to transcode between the different video formats that are supported by the imaging service platform. Transcoding is also utilized by wireless operators to support different voice codecs used in mobile telephone networks, and the corresponding voice transcoders are integrated into the RNC 414. Upgrading such a mobile imaging service platform with the architecture shown in FIG. 4 typically involves deploying new handsets 410, and manually adding new hardware to the MMSC 420 video gateway 422.

An all-software mobile imaging applications service platform constructed according to aspects of the present invention supports automated OTA upgrade of deployed handsets, and automated OTN upgrade of deployed MMSCs 420. A Java implementation of the mobile handset imaging application as described above provides improved handset/network robustness against viruses, worms, and other “attacks”, allowing mobile network operators to provide the quality and reliability of service required by national regulators.

The contemplation of deployment of mobile video messaging services exposes fundamental limitations in regard to current video compression technologies. On the one hand, such mobile video services will be launched into a market that now equates video with home cinema quality broadcast—full size image formats such as VGA 160 at 30 frames per second. On the other hand, processing of such large volumes of data using existing video technologies originally developed for broadcasting and streaming applications greatly exceeds the computing resources and battery power available for real-time video capture (encoding) in mobile handsets 410. Broadcast and streaming applications rely on the encoding of video content in a studio environment, where high-compleXity encoders can be run on computer workstations. Since video messages must be captured in real time in the handset itself, they are limited to much smaller sizes and much lower frame rates.

As a result, today's mobile video imaging services are primitive; pictures are small (QCIF) 130 and choppy (10 fps) in comparison to those that subscribers have long come to expect from the digital camcorders whose functionality video phones have been positioned to replicate. The primitive video image quality offered to mobile subscribers today also falls far short of the crisp high-definition video featured in the industry's lifestyle advertising. Mobile subscribers are demanding full VGA 160, 30 fps performance (i.e. just like their camcorder) before they will widely adopt and pay premium pricing for camcorder phones and related mobile video messaging services. With their 2.5G and 3G business models at risk, wireless operators are urgently seeking viable solutions to the above problem.

Even after far more expensive and time-consuming development programs, competing video codec providers can still only offer complex hybrid software codec plus hardware accelerator solutions for VGA 130, 30 fps performance, with overall cost and power consumption that far exceed commercial business requirements and technology capabilities. Handsets are thus limited to small choppy images, or expensive power-hungry architectures. Service deployment is too expensive, and quality of service is too low, to enable mass-market.

Upgrading MMSC infrastructure 420 is also costly if new hardware is required. An all software ASP platform would be preferable in order to enable automated OTA upgrade of handsets and OTN upgrade of MMSC 420 video gateways 422.

Improved Wavelet-Based Image Processing

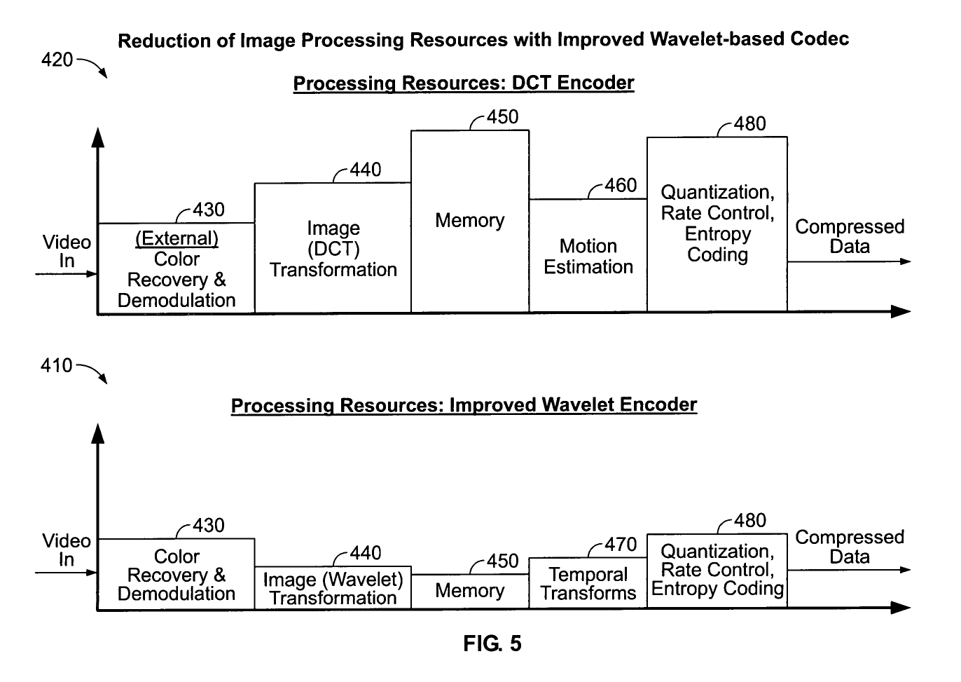

According to one aspect of the present invention, 3-D wavelet transforms can be exploited to design video compression/decompression (codec) devices 410 much lower in computational complexity than DCT-based codecs 420 (see FIG. 5). Processing resources used by such processes as color recovery and demodulation 430, image transformation 440, memory 450, motion estimation 460/temporal transforms 470, and quantization, rate control and entropy coding 480 can be significantly reduced by utilizing 3-D wavelet codecs according to some aspects of the present invention. The application of a wavelet transform stage also enables design of quantization and entropy-coding stages with greatly reduced computational complexity. Further advantages of the 3-D wavelet codecs 410 according to certain aspects of the present invention developed for mobile imaging applications, devices, and services include:

Symmetric, low-complexity video encoding and decoding

Lower processor power requirements for both software and hardware codec implementations

All-software encoding and decoding of VGA 160 (or larger) video at a frame rate of 30 fps (or higher) with processor requirements compatible with existing commercial mobile handsets, both as native code and as a Java application

Lower gate-count ASIC cores for SoC integration

Lower buffer memory requirements

Single codec supports both still images (˜JPEG) and video (˜MPEG)

Simplified video editing (cuts, inserts, text overlays,) due to shorter group of pictures (GOP)

Simplified synchronization with voice codecs, due to shorter GOP

Low latency for enhanced video streaming, due to shorter GOP

Fine grain scalability for adaptive rate control, multicasting, and joint source-channel coding

Low-complexity performance scaling to emerging HDTV video formats

According to aspects of the present invention, the above advantages are achieved by unique combinations of technologies as follows.

Wavelet transforms using short dyadic integer filter coefficients in the lifting structure: for example, the Haar, 2-6, and 5-3 wavelets and variations of them can be used. These use only adds, subtracts, and small fixed shifts—no multiplication or floating-point operations are needed.

Lifting Scheme computation: The above filters can advantageously be computed using the Lifting Scheme which allows in-place computation. A full description of the Lifting Scheme can be found in Sweldens, Wim, The Lifting Scheme: A custom-design construction of biorthogonal wavelets. Appl. Comput. Harmon. Anal. 3(2):186-200, 1996, incorporated herein by reference in its entirety. Implementing the Lifting Scheme in this application minimizes use of registers and temporary RAM locations, and keeps references local for highly efficient use of caches.

Wavelet transforms in pyramid form with customized pyramid structure: each level of the wavelet transform sequence can advantageously be computed on half of the data resulting from the previous wavelet level, so that the total computation is almost independent of the number of levels. The pyramid can be customized to leverage the advantages of the Lifting Scheme above and further economize on register usage and cache memory bandwidth.

Block structure: in contrast to most wavelet compression implementations, the picture can advantageously be divided into rectangular blocks with each block being processed separately from the others. This allows memory references to be kept local and an entire transform pyramid can be done with data that remains in the processor cache, saving a lot of data movement within most processors. Block structure is especially important in hardware embodiments as it avoids the requirement for large intermediate storage capacity in the signal flow.

Block boundary filters: modified filter computations can be advantageously used at the boundaries of each block to avoid sharp artifacts, as described in applicants' U.S. application Ser. No. 10/418,363, filed Apr. 17, 2003, published as 2003/0198395 and entitled WAVELET TRANSFORM SYSTEM, METHOD AND COMPUTER PROGRAM PRODUCT, incorporated herein by reference in its entirety.

Chroma temporal removal: in certain embodiments, processing of the chroma-difference signals for every field can be avoided, instead using a single field of chroma for a GOP. This is described in applicants' U.S. application Ser. No. 10/447,514, filed May 28, 2003, published as 2003/0235340 and entitled CHROMA TEMPORAL RATE REDUCTION AND HIGH-QUALITY PAUSE SYSTEM AND METHOD, incorporated herein by reference in its entirety.

Temporal compression using 3D wavelets: in certain embodiments, the very computationally expensive motion-search and motion-compensation operations of conventional video compression methods such as MPEG are not used. Instead, a field-to-field temporal wavelet transform can be computed. This is much less expensive to compute. The use of short integer filters with the Lifting Scheme here is also preferred.

Dyadic quantization: in certain embodiments, the quantization step of the compression process is accomplished using a binary shift operation uniformly over a range of coefficient locations. This avoids the per-sample multiplication or division required by conventional quantization.

Piling: in certain embodiments, the amount of data to be handled by the entropy coder is reduced by first doing a run-of-zeros conversion. Preferably, a method of counting runs of zeros on parallel processing architectures is used, as described in applicants' U.S. application Ser. No. 10/447,455, filed May 28, 2003, published as 2003/0229773 and entitled PILE PROCESSING SYSTEM AND METHOD FOR PARALLEL PROCESSORS, incorporated herein by reference in its entirety. Note that most modern processing platforms have some parallel capability that can be exploited in this way.

Cycle-efficient entropy coding: in certain embodiments, the entropy coding step of the compression process is done using techniques that combine the traditional table lookup with direct computation on the input symbol. Characterizing the symbol distribution in source still images or video leads to the use of such simple entropy coders as Rice-Golomb, exp-Golomb or the Dyadic Monotonic. The choice of entropy coder details will often vary depending on the processor platform capabilities. Details of the Rice-Golomb and exp-Golomb coders are described in: Golomb, S. W. (1966), “Run-length encodings”, IEEE Transactions on Information Theory, IT—12(3):399-401; R. F. Rice, “Some Practical Universal Noiseless Coding Techniques,” Jet Propulsion Laboratory, Pasadena, Calif., JPL Publication 79-22, March 1979; and J. Teuhola, “A Compression Method for Clustered Bit-Vectors,” Information Processing Letters, vol. 7, pp. 308-311, October 1978 (introduced the term “exp-Golomb”). Details of the Dyadic Monotonic coder are described in applicants' U.S. Pat. No. 6,847,317, issued Jan. 25, 2005 and entitled SYSTEM AND METHOD FOR A DYADIC-MONOTONIC (DM) CODEC. Each of the above references is incorporated herein by reference in its entirety.

Rate Control

One method of adjusting the amount of compression, the rate of output bits produced, is to change the amount of information discarded in the quantization stage of the computation. Quantization is conventionally done by dividing each coefficient by a pre-chosen number, the “quantization parameter”, and discarding the remainder of the division. Thus a range of coefficient values comes to be represented by the same single value, the quotient of the division.

When the compressed image or GOP is decompressed, the inverse quantization process step multiplies the quotient by the (known) quantization parameter. This restores the coefficients to their original magnitude range for further computation.

However, division (or equivalently multiplication) is an expensive operation in many implementations, in terms of power and time consumed, and in hardware cost. Note that the quantization operation is applied to every coefficient, and that there are usually as many coefficients as input pixels.

In another method, instead of division (or multiplication), quantization is limited to divisors that are powers of 2. This has the advantage that it can be implemented by a bit-shift operation on binary numbers. Shifting is very much less expensive operation in many implementations. An example is integrated circuit (FPGA or ASIC) implementation; a multiplier circuit is very large, but a shifter circuit is much smaller. Also, on many computers, multiplication requires longer time to complete, or offers less parallelism in execution, compared to shifting.

While quantization by shifting is very efficient with computation, it has a disadvantage for some purposes: it only allows coarse adjustment of the compression rate (output bit rate). According to aspects of the present invention, It is observed in practice that changing the quantization shift parameter by the smallest possible amount, +1 or −1, results in nearly a 2-fold change in the resulting bit rate. For some applications of compression, this may be acceptable. For other applications, finer rate control is required.

In order to overcome the above coarseness problem of the prior art without giving up the efficiency of shift quantization, the quantization is generalized. Instead of using, as before, a single common shift parameter for every coefficient, we provide for a distinct shift parameter to be applied to each separate run-of-zeros compressed storage area or pile. The parameter value for each such area or pile is recorded in the compressed output file. A pile is a data storage structure in which data are represented with sequences of zeros (or of other common values) compressed. It should be noted that a subband may comprise several separate piles or storage areas. Alternately, a pile or storage area may comprise several separate subbands.

This solution now allows a range of effective bit rates in between the nearest two rates resulting from quantization parameters applied uniformly to all coefficients. For example, consider a case in which all subbands but one (subband x) use the same quantization parameter, Q, and that one (subband x) uses Q+1. The resulting overall bit rate from the quantization step is reduced as compared to using Q for all subbands in the quantization, but not to the degree as if Q+1 were used for all subbands. This provides an intermediate bit rate between that achieved by uniform application of Q or Q+1, giving a better, finer control of the compression.

Note that the computational efficiency is almost exactly that of pure shift quantization, since typically the operation applied to each coefficient is still a shift. Any number of subbands can be used. Four to one-hundred subbands are typical. Thirty-two is most typical. Further information on rate control is provided in applicants' U.S. application Ser. No. ______ filed Sep. 20, 2005 entitled COMPRESSION RATE CONTROL SYSTEM AND METHOD WITH VARIABLE SUBBAND PROCESSING (Attorney Docket No. 74189-200301/US), incorporated herein by reference in its entirety.

Improved Adaptive Joint Source-Channel Coding

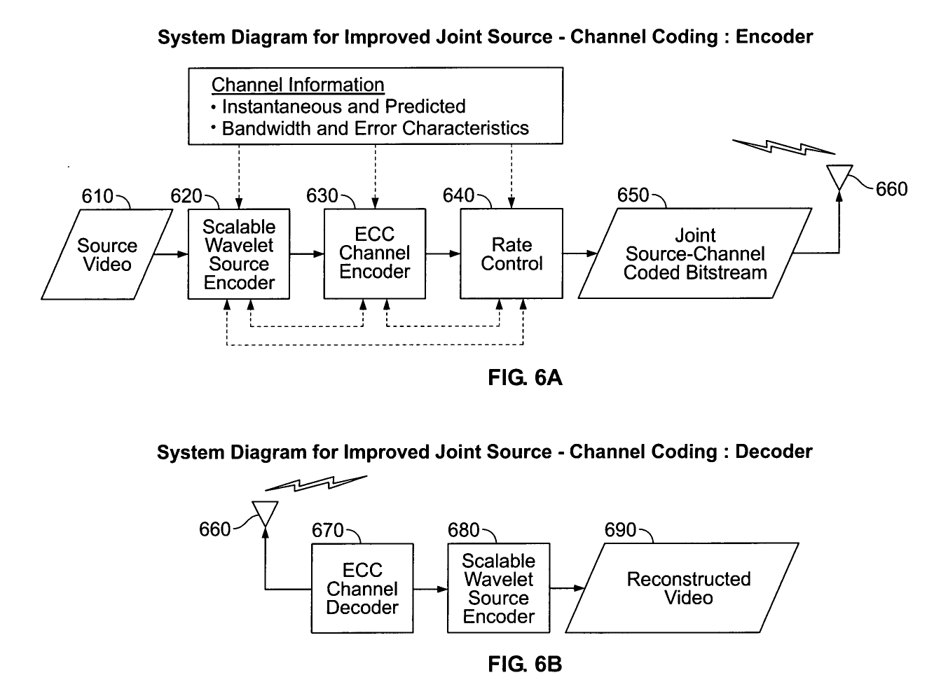

Referring now to FIG. 6, the fine grain scalability of the improved wavelet-based codec described above enables improved adaptive rate control, multicasting, and joint source-channel coding. The reduced computational complexity and higher computational efficiency of the improved wavelet algorithms allows information on both instantaneous and predicted channel bandwidth and error conditions to be utilized in all three of the source coder 620, the channel coder 630, and the rate controller 640 to maximize control of both the instantaneous and average compression rates which affect the quality (video rate vs. distortion) of the reconstructed video signal 690 (see FIG. 6). For example, available transmission bandwidth between a mobile device 410 and a cellular transmission tower 412 (shown in FIG. 4) can vary based on the number of users accessing the tower 412 at a particular time. Similarly, the quality of the transmission between the mobile phone 410 and tower 412 (i.e. error rate) can vary based on the distance and obstructions between the phone 410 and tower 412. Information on the currently available bandwidth and error rate can be received by the phone 410 and used to adjust the compression rate accordingly. For instance, when the bandwidth goes down and/or the error rate goes up, the compression rate (and therefore the associated reproduced picture quality) can be reduced so that the entire compressed signal can still be transmitted in real time. Conversely, when the available bandwidth increases and/or the error rate decreases, the compression rate can be decreased to allow for a higher quality picture to be transmitted. Based on this feedback, the compression rate can be adjusted by making real time processing changes in either the source encoder 620, the channel encoder 630 or the rate controller 640, or with changes to a combination of these elements.

Example rate change increments can vary from 1 to 5%, from 1 to 10%, from 1 to 15%, from 1 to 25%, and from 1 to 40%

The improved adaptive joint-source channel coding technique allows wireless carriers and MMS service providers to offer a greater range of quality-of-service (QoS) performance and pricing levels to their consumer and enterprise customers. Utilizing improved adaptive joint-source channel coding based on algorithms with higher computational efficiency enables support for a much higher level of network heterogeneity, in terms of channel types (wireless and wire line), channel bandwidths, channel noise/error characteristics, user devices, and user services.

Improved Mobile Imaging Handset Platform Architecture

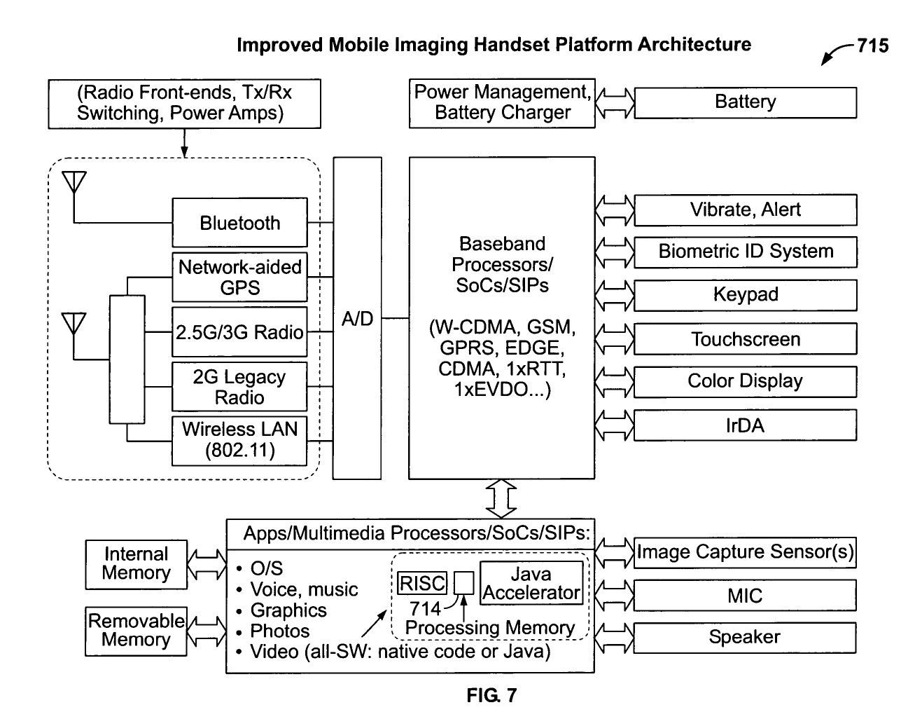

FIG. 7 illustrates an improved mobile imaging handset platform architecture. As shown, the imaging application can be implemented as an all-software application running as native code or as a Java application on a RISC processor. Acceleration of the Java code operation may be implemented within the RISC processor itself, or using a separate Java accelerator IC. Such a Java accelerator may be implemented as a stand-alone IC, or this IC may be integrated with other functions in either a SIP or SoC.

The improved mobile imaging handset platform architecture illustrated in FIG. 7 eliminates the need for separate DSP 326 or ASIC 328 processing blocks (shown in FIG. 3) for the mobile imaging application, and also greatly reduces the buffer memory 714 requirements for image processing in the mobile handset 715.

Improved Mobile Imaging Service Platform Architecture

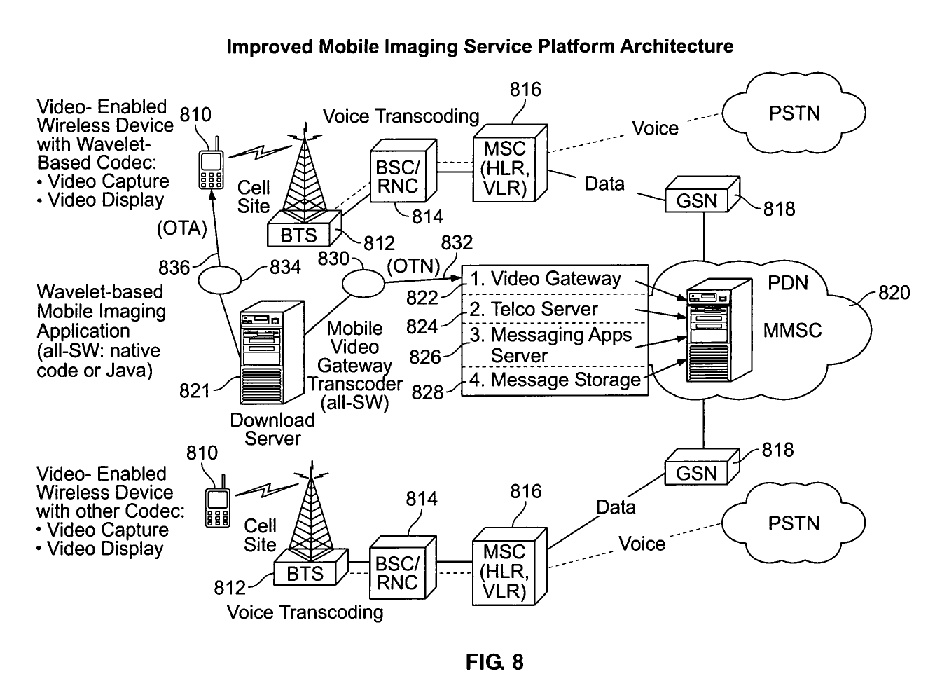

Referring now to FIG. 8, key components of an improved mobile imaging service platform architecture can include:
Mobile Handsets 810
Mobile Base stations (BTS) 812
Base station Controller/Radio Network Controller (BSC/RNC) 814
Mobile Switching Center (MSC) 816
Gateway Service Node (GSN) 818
Mobile Multimedia Service Controller (MMSC) 820
Imaging Service Download Server 821

Typical functions included in the MMSC (see FIG. 8) can include:
Video Gateway 822
Telco Server 824
MMS Applications server 826
Storage Server 828

The steps involved in deploying the improved imaging service platform include:

Step 1.

Signal the network that a Video Gateway Transcoder application 830 is available for updating on the deployed Video Gateways 822. In other words, when new transcoder software 830 is available, the download server 821 signals the video gateways 822 on the network of this availability.

Step 2.

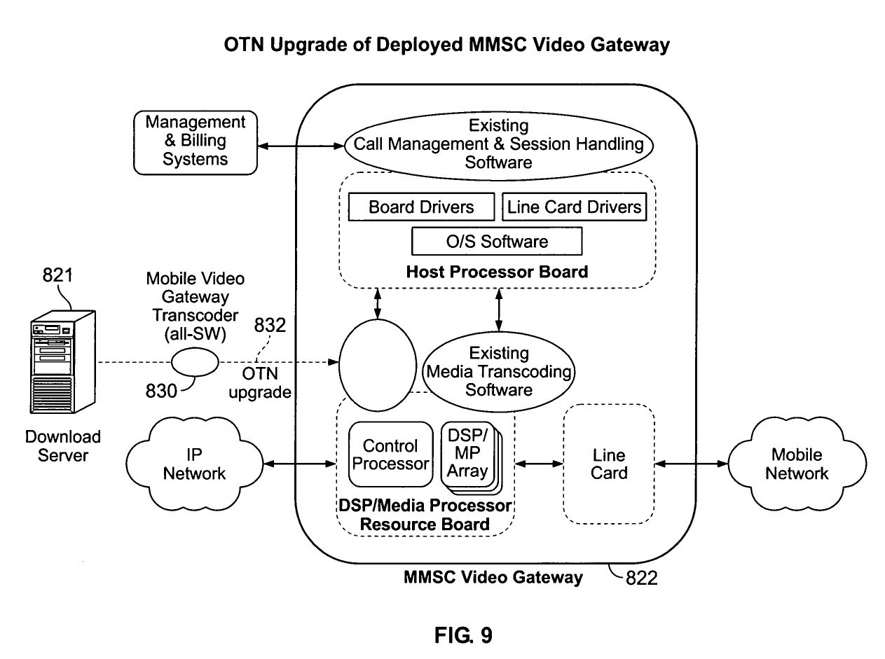

Install and configure Video Gateway Transcoder Software application 830 via automated OTN 832 deployment or via manual procedures (see also FIG. 9).

Step 3.

Signal subscriber handset that Mobile Video Imaging Application 834 (e.g. an updated video codec) is available for download and installation.

Step 4.

If accepted by subscriber, and transaction settlement is completed successfully, download and install Mobile Video Imaging Application 834 on mobile handset 810 via OTA 836 procedures.

Step 5.

Signal network that handset upgrade is complete. Activate service and related applications. Update subscriber monthly billing records to reflect new charges for Mobile Video Imaging Application.

Performance

This improved wavelet-based mobile video imaging application, joint source-channel coding, handset architecture, and service platform architecture achieve the goal of higher mobile video image quality, lower handset cost and complexity, and reduced service deployment costs.

Enhancements

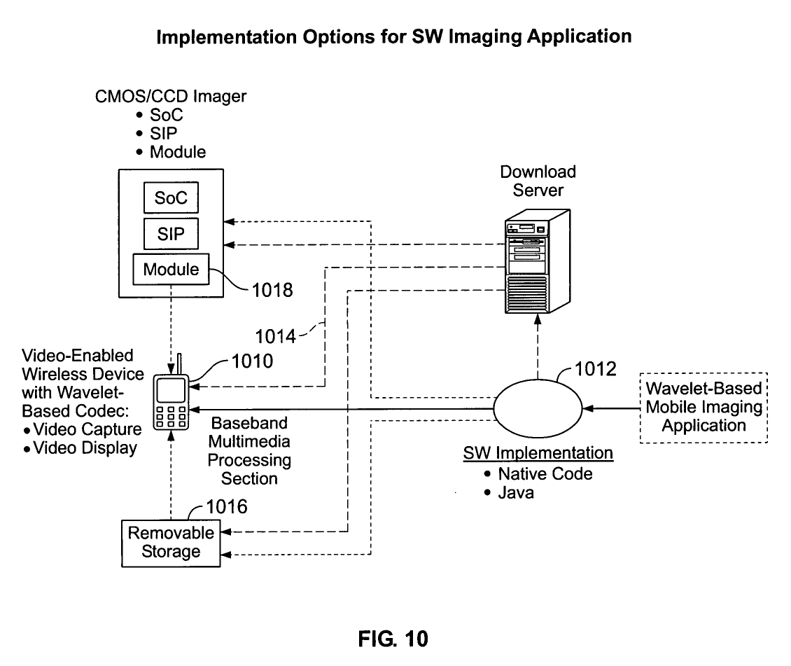

Referring now to FIG. 10, as an enhancement to the mobile imaging handset 1010 architecture, in some embodiments several implementation options can be considered for the all-software wavelet-based imaging application 1012. The imaging application 1012 can be installed via OTA download 1014 to the baseband multimedia processing section of the handset 1010, to a removable storage device 1016, to the imaging module 1018 or other location. Where desirable, the imaging application 1012 can also be installed during manufacturing or at point-of-sale to the baseband multimedia processing section of the handset 1010, to a removable storage device 1016, to the imaging module 1018 or other location. Additional implementation options are also possible as mobile device architectures evolve.

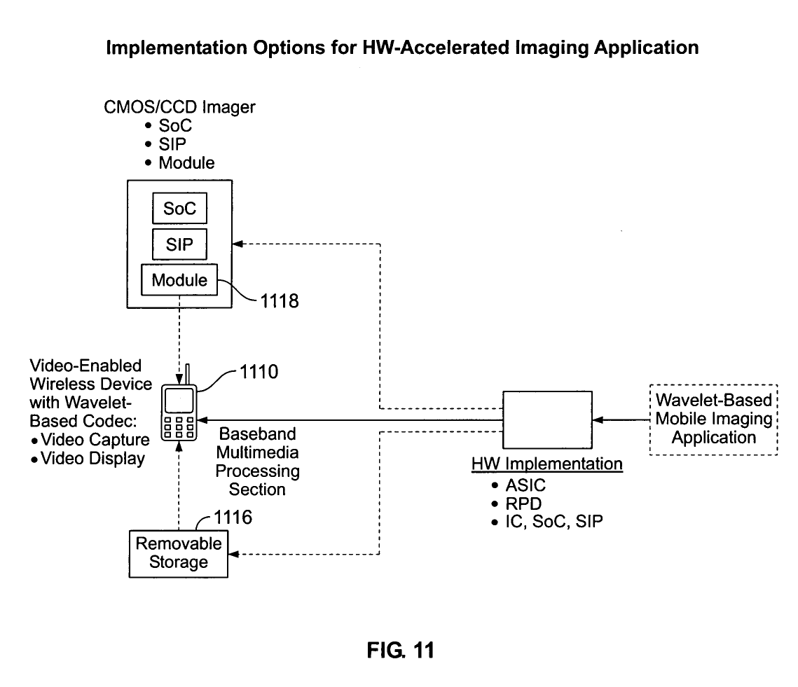

Performance of the mobile imaging handset may be further improved, and costs and power consumption may be further reduced, by accelerating some computational elements via hardware-based processing resources in order to take advantage of ongoing advances in mobile device computational hardware (ASIC, DSP, RPD) and integration technologies (SoC, SIP). Several all-hardware options can be considered for integrating these hardware-based processing resources in the handset 1110 (see FIG. 11), including the baseband multimedia processing section of the handset 1110, a removable storage device 1116, or the imaging module 1118.

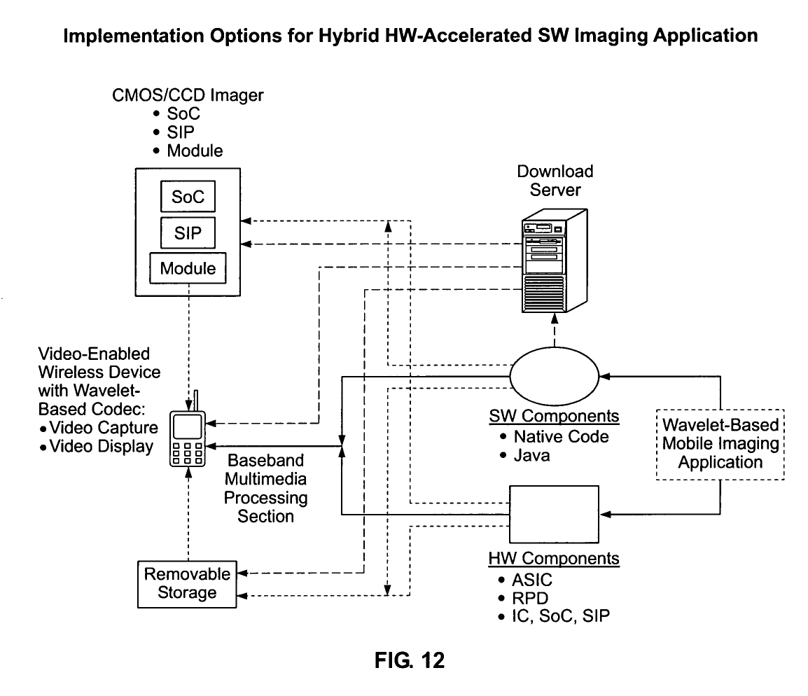

As shown in FIG. 12, hybrid architectures for the imaging application may offer enhancements by implementing some computationally intensive, repetitive, fixed functions in hardware, and implementing in software those functions for which post-manufacturing modification may be desirable or required.

Advantages

The all-software imaging solution embodiments described here substantially reduce baseband processor and video accelerator costs and requirements in multimedia handsets. Combined with the ability to install the codec post-production via OTA download, this all-software solution can substantially reduce the complexity, risk, and cost of both handset development and video messaging service deployment.

It should also be noted that when using certain video codecs according to aspects of the present invention, the data representing a particular compressed video can be transmitted over the telecommunications network to the MMSC and that the data can have attached to it a decoder for the compressed video. In this fashion according to aspects of the present invention, it is possible to do away with entirely or to some degree the video Gateway that is otherwise necessary to transcoder video data coming in to the MMSC. This, in part, is facilitated because since each compressed video segment can have its own decoder attached to it, it is not necessary for the MMSC to transcode the video format to a particular video format specified by the receiving wireless device. Instead, the receiving wireless device, for example 810, can receive the compressed video with attached decoder and simply play the video on the platform of the receiving device 810. This provides a significant efficiency and cost savings in the structure of the MMSC and its operations.

An additional aspect of the present invention is that the wavelet processing can be designed to accomplish additional video processing functions on the video being processed. For example, the wavelet processing can be designed to accomplish color space conversion, black/white balance, image stabilization, digital zoom, brightness control, and resizing as well as other functions.

Another particular advantage of aspects of the present invention lies in the significantly improved voice synchronization accomplished. With embodiments of the present invention the voice is synchronized to every other frame of video. By comparison, MPEG4 only synchronizes voice to every 15th frame. This results in significant de-synchronization of voice with video, particularly when imperfect transmission of video is accomplished as commonly occurs over mobile networks. Additionally, having voice synchronized to every other frame of video when that video is embodied in the MMSC provides for efficient and expedited editing of the video in the MMSC where such may be done in programs such as automatic or remotely enabled video editing. Additionally, aspects of the present invention are presented in as much as the present encoding techniques allow the embedding of significantly more, or significantly more easily embedded, metadata in the video being generated and compressed. Such metadata can include, among other items, the time, the location where the video was captured (as discerned from the location systems in the mobile handset) and the user making the film. Furthermore, because there is a reference frame in every other frame of video in certain embodiments of the present invention, as compared to a reference frame in every 15 frames of video in MPEG-4 compressed video, embodiments of the present invention provide highly efficient searching of video and editing of video as well as providing much improved audio synchronization.

### CONCLUSION

An improved mobile imaging application, handset architecture, and service platform architecture, are provided by various aspects of the present invention which combine to substantially reduce the technical complexity and costs related with offering high-quality still and video imaging services to mobile subscribers. Improved adaptive joint-source channel coding technique is the corresponding ability of wireless carriers and MMS service providers to offer a greater range of quality-of-service (QoS) performance and pricing levels to their consumer and enterprise customers, thus maximizing the revenues generated using their wireless network infrastructure. Improved adaptive joint-source channel coding, based on algorithms with higher computational efficiency, enables support for a much higher level of network homogeneity, in terms of channel types (wireless and wire line), channel bandwidths, channel noise/error characteristics, user devices, and user services.

While the above is a complete description of the preferred embodiments of the invention, various alternatives, modifications, and equivalents may be used. Therefore, the above description should not be taken as limiting the scope of the invention which is defined by the appended claims.

What is claimed is:

1. An improved method of joint source-channel coding, wherein the joint source-channel coding sequentially processes source video to be compressed in a source encoder stage, a channel encoder stage and a rate controller stage to produce a joint source-channel coded bitstream, the improvement comprising:
determining a change in at least one of a transmission bandwidth parameter and a transmission error rate parameter;
changing the process of at least one of the source encoder stage, the channel encoder stage and the rate control stage in response to the at least one determined change.

2. The method of claim 1, wherein at least one of the parameters is an instantaneous parameter.

3. The method of claim 1, wherein at least one of the parameters is a predicted parameter.

4. The method of claim 1, wherein at least one of the parameters is an average parameter.

5. The method of claim 1, wherein the improvement further comprises providing a source encoder stage that is scalable and utilizes wavelets.

6. The method of claim 1, wherein at least one of the parameters is received from a cellular telephone signal tower.

7. The method of claim 1, wherein changing the process of at least one of the stages results in a rate change increment in a range of about 1 to 40 percent.

8. The method of claim 1, wherein changing the process of at least one of the stages results in a rate change increment in a range of about 1 to 5 percent.
